(19) United States
(12) Patent Application Publication
(10) Pub. No.: US 2026/0088905 A1
(43) Pub. Date: Mar. 26, 2026

(54) MARKERS FOR DUAL-POLARIZATION OPTICAL SYSTEMS

(71) Applicant: Aloe Semiconductor Inc., Middletown, NJ (US)

(72) Inventors: Christopher R. Doerr, Middletown, NJ (US); Ying Zhao, Holmdel, NJ (US)

(21) Appl. No.: 18/891,906

(22) Filed: Sep. 20, 2024

(51) Int. Cl. H04B 10/50; H04B 10/61; H04J 14/06

(52) U.S. Cl. CPC H04B 10/50575; H04B 10/50577; H04B 10/6166; H04J 14/06

(57) ABSTRACT

An optical system includes a first modulator configured to: receive first input light, modulate an amplitude of the first input light with a first data signal, modulate a phase of the first input light with a first marker signal, and output to an optical element, as first modulated light, the first input light modulated with the first data signal and the first marker signal. The optical system includes a second modulator configured to: receive second input light, modulate an amplitude of the second input light with a second data signal, modulate a phase of the second input light with a second marker signal, and output to the optical element, as second modulated light, the second input light modulated with the second data signal and the second marker signal. The second marker signal includes a complementary version of the first marker signal.

### TECHNICAL FIELD

The present disclosure generally relates to transmitters for optical communication systems.

### BACKGROUND

In optical communication systems, multiplexing techniques (such as polarization-division multiplexing (PDM)) can increase communication capacity and/or photon efficiency by multiplexing different signals over different channels (e.g., different polarization modes) for simultaneous transmission through a single fiber. However, a challenge of using PDM is that the polarization modes tend to undergo random and unpredictable rotations and losses as they propagate through an optical communication system, for example due to stress in the glass fiber (bending and twisting), ambient temperature changes, or other non-idealities in the communication system. As a result, the signals in the different polarization modes become mixed among each other when they are received, resulting in crosstalk between signals on the different channels. In such scenarios, the signals must be unmixed at the receiver through multiple-input-multiple-output (MIMO) demultiplexing.

### SUMMARY

Some aspects of the present disclosure relate to an optical system including: a first modulator configured to: receive first input light, modulate an amplitude of the first input light with a first data signal, modulate a phase of the first input light with a first marker signal, and output to an optical element, as first modulated light, the first input light modulated with the first data signal and the first marker signal. The optical system includes a second modulator configured to: receive second input light, modulate an amplitude of the second input light with a second data signal, modulate a phase of the second input light with a second marker signal, and output to the optical element, as second modulated light, the second input light modulated with the second data signal and the second marker signal. The second marker signal includes a complementary version of the first marker signal.

This and other optical systems described herein can have one or more of at least the following characteristics.

In some implementations, modulation of the phase of the first input light and modulation of the phase of the second input light are based on modulation of bias voltages of the first modulator and the second modulator, respectively.

In some implementations, the optical system includes a marker signal generation circuit configured to provide the first marker signal with a frequency in a range from 100 kHz to 500 MHz.

In some implementations, the optical system includes a data signal generation circuit configured to provide the first data signal with a frequency of at least 1 GHz.

In some implementations, the first modulator is configured to modulate the phase of the first input light with the first marker signal at a frequency in a range from 100 kHz to 500 MHz.

In some implementations, the optical system includes: a laser source configured to output laser light; and an optical splitter configured to split the laser light into a first transmission path and a second transmission path. The first transmission path provides the split laser light to the first modulator as the first input light, and the second transmission path provides the split laser light to the second modulator as the second input light.

In some implementations, the optical element includes a polarization splitter and rotator (PSR).

In some implementations, the optical system includes a receiver configured to perform dual-polarization demultiplexing to recover the first data signal and the second data signal.

In some implementations, the receiver is configured to perform the dual-polarization demultiplexing using the first marker signal and the second marker signal.

In some implementations, the first modulator and the second modulator include Mach-Zehnder interferometer modulators.

In some implementations, the first modulator and the second modulator include ring resonator modulators.

In some implementations, the optical system includes a dual-polarization optical system.

Some aspects of this disclosure relate to an optical transmitter that includes: an optical modulator including at least one data input and a bias input, the bias input distinct from the at least one data input. The optical modulator is configured to: receive a data signal at the data input and modulate an amplitude of light with the data signal, receive, at the bias input, a bias signal and a marker signal, and modulate a phase of the light with the marker signal.

This and other optical transmitters described herein can have one or more of at least the following characteristics.

In some implementations, the bias signal includes a DC signal and the marker signal includes an AC signal.

In some implementations, the optical modulator includes a Mach-Zehnder interferometer, and the bias input is a common bias input for two arms of the Mach-Zehnder interferometer.

In some implementations, the common bias input includes a diode anode of each of the two arms or a diode cathode of each of the two arms.

In some implementations, the optical transmitter includes: a first optical phase-shifter connected between the bias input and a first data input of the at least one data input, and a second optical phase-shifter connected between the bias input and a second data input of the at least one data input. The first optical phase-shifter and the second optical phase-shifter are connected as an interferometer to modulate the amplitude of the light.

In some implementations, the first optical phase-shifter and the second optical phase-shifter include depletion-mode phase-shifters.

In some implementations, the optical transmitter includes a marker signal generation circuit configured to generate the marker signal and apply the marker signal to the bias input.

In some implementations, the optical transmitter includes a marker signal generation circuit configured to modulate the bias signal with the marker signal.

In some implementations, the optical modulator is a first optical modulator configured to output the light as first output light, the marker signal is a first marker signal, the optical transmitter includes a second optical modulator, and the second optical modulator is configured to modulate a phase of second output light with a second marker signal including a complementary version of the first marker signal.

In some implementations, the first optical modulator and the second optical modulator are coupled together by a polarization splitter and rotator.

In some implementations, the optical transmitter is a dual-polarization optical transmitter.

In some implementations, the optical transmitter includes silicon waveguides through which the light is routed.

Some aspects of this disclosure describe an optical transmitter including: a first optical phase-shifter connected between a first differential data input and a bias input; a second optical phase-shifter connected between a second differential data input and the bias input; and a marker input configured to receive a marker signal, the marker input distinct from the first differential data input and the second differential data input. The first optical phase-shifter and the second optical phase-shifter are configured to together modulate an amplitude of output light based on a data signal applied at the first and second differential data inputs. The marker input is connected to modulate a phase of the output light based on the marker signal.

This and other optical transmitters described herein can have one or more of at least the following characteristics.

In some implementations, the marker input includes the bias input.

In some implementations, the marker input is connected to apply the marker signal as a common-mode signal to the first optical phase-shifter and the second optical phase-shifter.

In some implementations, the marker input is connected to the first differential data input and the second differential data input through a termination resistor of the optical transmitter.

In some implementations, the marker input is connected to the first optical phase-shifter and the second optical phase-shifter through a termination resistor of the optical transmitter.

In some implementations, the first optical phase-shifter and the second optical phase-shifter include respective diodes, each diode of the respective diodes including: one of an anode or cathode connected to the first differential data input or the second differential data input, and the other of the anode or the cathode connected to the bias input.

In some implementations, the first optical phase-shifter and the second optical phase-shifter include depletion-mode phase-shifters.

In some implementations, the optical transmitter includes a marker signal generation circuit configured to generate the marker signal and apply the marker signal to the marker input.

In some implementations, the marker signal generation circuit is connected to the bias input.

In some implementations, the optical transmitter includes a marker signal generation circuit configured to modulate a bias signal with the marker signal, the bias signal applied to the bias input.

In some implementations, the optical modulator is a first optical modulator, the output light is first output light, the marker signal is a first marker signal, the optical transmitter includes a second optical modulator, and the second optical modulator is configured to modulate a phase of second output light with a second marker signal including a complementary version of the first marker signal.

In some implementations, the first optical modulator and the second optical modulator are coupled together by a polarization splitter and rotator.

In some implementations, the optical transmitter is a dual-polarization optical transmitter.

Some aspects of this disclosure relate to an optical transmitter including: a differential optical modulator including: a first optical phase-shifter including a first anode and a first cathode, and a second optical phase-shifter including a second anode and a second cathode. The optical transmitter includes a marker signal generation circuit configured to apply a marker signal to (i) the first and second anodes or (ii) the first and second cathodes.

Some aspects of this disclosure relate to an optical transmitter including: a differential optical modulator including two transmission paths, the differential optical modulator configured to: provide light through the two transmission paths, modulate an amplitude of the light with a data signal based on interference between light output from the two transmission paths, and modulate a phase of the light with a marker signal that operates on the light in both of the two transmission paths as a common-mode signal.

This and other optical transmitters described herein can have one or more of at least the following characteristics.

In some implementations, the optical transmitter includes a termination resistor through which the marker signal is applied.

In some implementations, the optical transmitter includes a marker input configured to receive the marker signal, the marker input arranged at a midpoint of the termination resistance.

In some implementations, a first resistance between the marker input and a first data signal terminal based on which the data signal operates on a first transmission path of the two transmission paths, is equal to a second resistance between the marker input and a second data signal terminal based on which the data signal operates on a second transmission path of the two transmission paths.

In some implementations, the optical transmitter includes: a data signal input configured to receive the data signal, and a capacitor connected between the data signal input and the marker input.

In some implementations, the differential optical modulator includes a data input and a bias input, the bias input distinct from the data input. The data input is configured to receive the data signal, and the bias input is configured to receive (i) a bias signal and (ii) the marker signal.

In some implementations, the differential optical modulator includes a Mach-Zehnder interferometer, and the bias input is a common bias input for two arms of the Mach-Zehnder interferometer.

In some implementations, the common bias input includes a diode anode of each of the two arms or a diode cathode of each of the two arms.

In some implementations, the optical transmitter includes a marker signal generation circuit configured to generate the marker signal.

In some implementations, the marker signal generation circuit is configured to generate the marker signal as a modulation of a bias voltage for two arms of the differential optical modulator.

In some implementations, the differential optical modulator is a first optical modulator configured to output the light as first output light, the marker signal is a first marker signal, the optical transmitter includes a second optical modulator, and the second optical modulator is configured to modulate a phase of second output light with a second marker signal including a complementary version of the first marker signal.

In some implementations, the first optical modulator and the second optical modulator are coupled together by a polarization splitter and rotator.

In some implementations, the optical transmitter is a dual-polarization optical transmitter.

The details of one or more implementations of the subject matter of this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example of an optical transmitter.

FIG. 2 is a diagram illustrating an example of an optical transmitter.

FIG. 3 is a diagram illustrating an example of an optical transmitter.

FIG. 4 is a diagram illustrating an example of an optical receiver.

FIG. 5 is a diagram illustrating output power as a function of differential phase.

### DETAILED DESCRIPTION

In a dual-polarization (DP) communication system, two data signals are transmitted on a single channel using two differently-polarized (e.g., orthogonally-polarized) optical signals. A receiving system perform polarization demultiplexing to isolate the two optical signals and extract the embedded data signals. To aid in demultiplexing, a marker signal may be added to one or both optical signal. The marker signal can be a relatively low-frequency signal, e.g., having a frequency significantly lower than the baud rate (frequency of the data signals).

For example, the marker signal can be used for demultiplexing feedback in an intensity-modulated direct-detection (IMDD) system, such as those described in U.S. patent application Ser. No. 18/235,032 or corresponding homodyne (single-wavelength) systems, the foregoing application being incorporated herein by reference in its entirety. In the context of DP-IMDD systems, the presence of a marker signal may be particularly beneficial, because DP-IMDD systems may perform primary demultiplexing optically without access to a baud-rate receiver, so as to perform signal reception using much lower-speed (less expensive, less power-consuming, etc.) electronics than would be required for a full baud rate receiver. This contrasts with some coherent receiving systems, which employ baud-rate or higher analog-to-digital converters (ADCs).

One approach to adding a marker to an optical signal is to add an amplitude marker. For example, the amplitude marker signal can be applied on top of the data signal in an optical modulator (e.g., a Mach-Zehnder modulator (MZM)) using a bias-tee. However, the use of an amplitude marker incurs a performance penalty, because the data signal is also amplitude-based, such that, for example, eye closure may be observed in an eye diagram. Furthermore, the addition of the marker signal to a high-frequency signal input/portion carrying the data signal may be difficult, e.g., resulting in adding noise and/or other undesired signal components to the resulting modulated light signals due to high-frequency effects such as reflection. The marker signal may be added using a separation modulation section, but this may add length, complexity, cost, and/or optical loss to the modulator.

Some implementations according to the present disclosure add a phase marker to modulated light signals, for example, in the context of a DP transmitter. For example, the phase marker can be a differential phase marker added to both optical signals in a DP transmitter. As described herein, the phase markers can be applied in various ways without requiring significant additional circuitry and without the drawbacks associated with the use of amplitude markers.

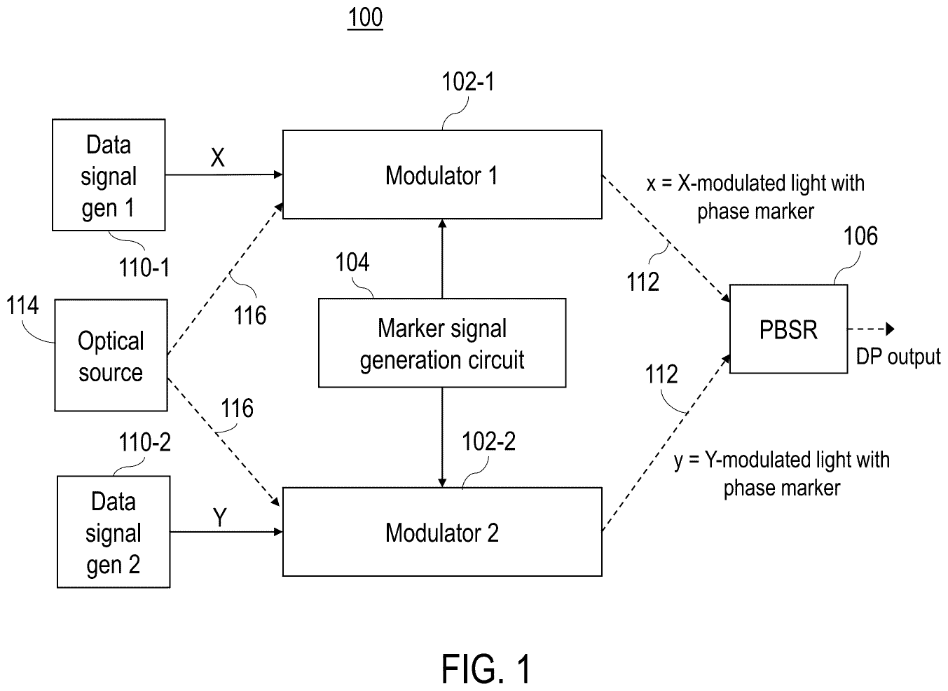

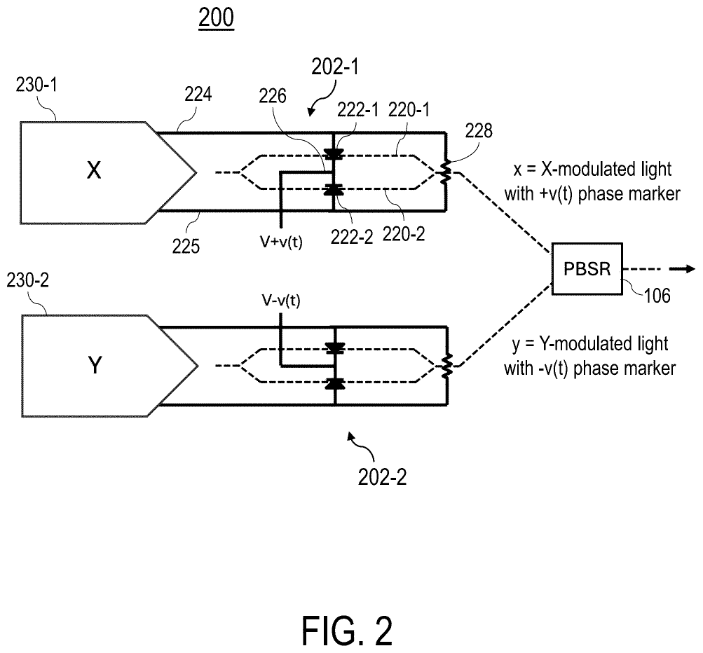

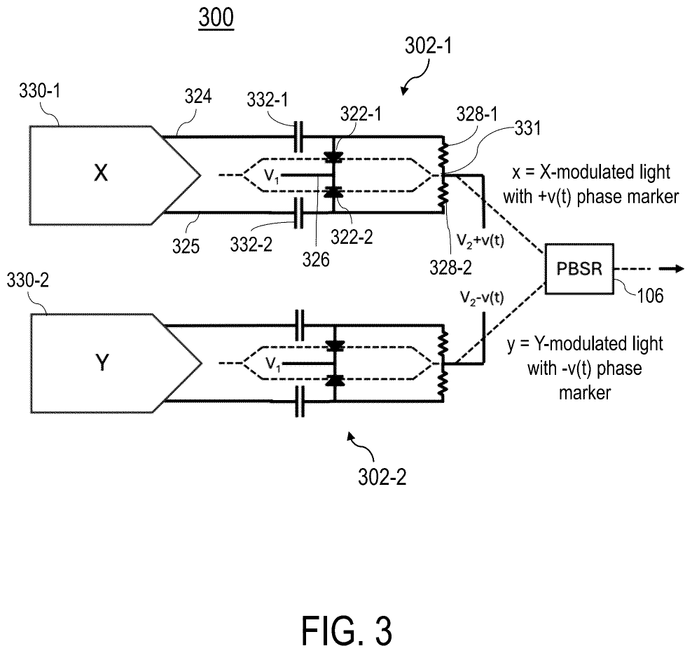

FIG. 1 illustrates an example of a dual-polarization optical transmitter 100. The transmitter 100 includes two modulators 102-1, 102-2 that receive respective signals X and Y from respective data generation circuits 110-1, 110-2. The modulators 102-1, 102-2 also receive input light from an optical source 114 over transmission paths 116 and modulate the light (e.g., by performing amplitude modulation) to provide, onto transmission paths 112, output x and y (X-modulated and Y-modulated light), one or both of which includes a phase marker. Examples of the modulators 102-1, 102-2 are discussed below with respect to FIGS. 2-3.

The optical source 114 can be, for example, a laser source outputting laser light that is split, in a “homodyne” system, for transmission to the modulators 102-1, 102-2. In some implementations, separate light sources 114 output light to the first modulator 102-1 and the second modulator 102-2, respectively. In some implementations, in a “heterodyne” system, separate light sources 114 output light of different respective wavelengths to the modulators 102-1, 102-2.

A laser included in the optical source 114 can be any suitable type of laser, for example, a distributed-feedback laser (DFB), a vertical-cavity surface-emitting laser (VCSEL), or a laser diode. In some implementations, light from the laser is coupled to further optical elements by an in-coupler and provided to a an optical splitter (1×2 coupler) that splits the light and provides the split light into the modulators 102-1, 102-2. Various wavelengths of the light are within the scope of this disclosure. In some implementations, the light from the laser is infrared light, e.g., 1311 nm light emitted from a DFB.

In some implementations, because modulation is performed using the modulators 102-1, 102-2 external to the optical source 114, the optical source 114 need not include integrated modulation, e.g., as an electro-absorption modulated laser (EML) (though in some implementations the light source 114 is an EML). This characteristic can provide increased design flexibility, decreased cost, and/or improved optical performance compared to systems that rely on EMLs for providing input light. Moreover, the use of a single light source 114, in some implementations, to provide the input light (e.g., as opposed to two or more light sources in heterodyne systems) can reduce system cost and complexity.

The transmission paths 112, 116 can be, for example, waveguides and/or optical fibers.

The modulators 102-1, 102-2 can include any suitable type of optical modulator. For example, in some implementations, the modulators 102-1, 102-2 are Mach-Zehnder modulators (MZMs) that modulate light using interference between light provided through two transmission paths. In some implementations, the modulators 102-1, 102-2 are electro-absorption modulators (EAMs). In some implementations, the modulators 102-1, 102-2 are ring resonator modulators.

In some implementations, the data generation circuits 110-1, 110-2 are or include serializer/deserializers (SERDES). The SERDES can includes high-speed digital-to-analog converters (DACs) that provide the signals X and Y. For example, the data generation circuits 110-1, 110-2 can include retimer digital signal processors (DSPs) or electronic switches that include the SERDES.

In some implementations, the data signal generation circuits 110-1, 110-2 are external to the transmitter 100. The data signals X and Y can accord to various protocols, such as PAM4, PAM6, PAM8, or DMT, to provide several non-limiting examples. The data signals X and Y can be high-frequency signals. For example, in some implementations X and Y have frequencies of at least 1 GHz, at least 10 GHz, at least 50 GHz, at least 100 GHz, or at least 200 GHz.

The transmitter 100 further includes one or more marker signal generation circuit(s) (collectively referred to as a marker signal generation circuit 104) that provides marker signals to one or both of the modulators 102-1, 102-2. One or both of the modulators 102-1, 102-2 are configured to phase-modulate the input light according to the marker signals, such that the output light on transmission paths 112 has a phase marker. In the example of FIG. 1, both modulators 102-1, 102-2 receive marker signals and cause a phase marker to be present in the output light. In some implementations, this can be beneficial for reasons discussed below with respect to FIG. 2. In some implementations, the marker signal generation circuit 104 provides bias voltage(s), such that the marker signal generation circuit provides the marker signals as a modulation of the bias bias voltage(s).

The marker signal can be a periodic signal with a frequency less than that of the data signals X and Y. For example, in some implementations, the marker signal has a frequency of at least 100 kHz, a frequency range that is compatible with tone detection at a speed acceptable for effective feedback control in a receiver. These frequencies may be incompatible with the use of thermal phase shifters, which may be limited to kHz speeds or below. In some implementations, the marker signal has a frequency of 1 GHz or less, 500 MHz or less, 100 MHz, 50 MHz or less, or 10 MHz or less. In some implementations, lower frequencies are preferable for the marker signal, because the use of lower frequencies permits the use of relatively simple, small, and/or inexpensive circuits to generate and input the marker signals, e.g., as opposed to the more complex circuitry that may be required to properly input GHz or higher-speed signals.

The marker signal may have any suitable periodic shape. For example, the marker signal can be a sine wave, a square wave, a triangle wave, a sawtooth wave, or a combination of two or more periodic signals of those and/or other periodic signal types. For example, the marker signal can be a 1 MHz sine wave signal. The marker signal generation circuit 104 can be, for example, an analog and/or digital signal generation circuit, waveform generator circuit, etc.

The two modulated optical waveforms x and y are combined in a polarization beam splitter and rotator (PBSR) 106 (sometimes referred to as a polarization combiner and rotator), which converts one of the optical waveforms into an orthogonal polarization. Throughout this disclosure, although examples are shown of a splitter implemented by a PBSR, other types of splitters can be used, including passive photonic integrated devices such as a polarization splitting grating coupler (PSGC). Moreover, throughout this disclosure, polarization rotation/alteration need not be performed in a combined optical element with splitting/combining but, rather, may be performed separately. For example, one of the optical waveforms x or y can be first rotated to have an orthogonal polarization, continue transmission on a transmission path, and then be combined with the other waveform x or y.

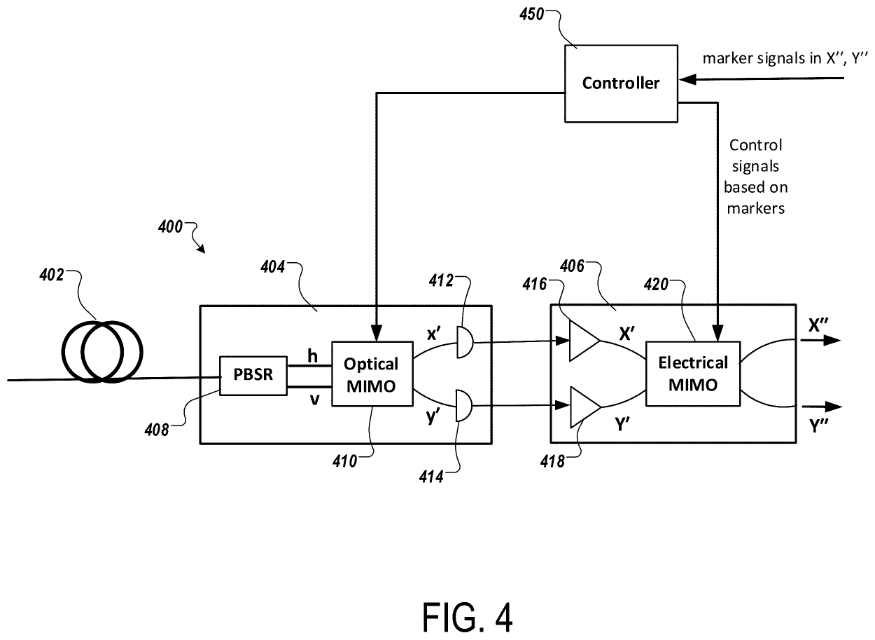

After the PBSR 106, the two optical waveforms x and y coexist in the same optical transmission path but have orthogonal polarizations. This dual-polarized (DP) optical waveform travels through a fiber link or other transmission link to a receiver, e.g., as described in reference to FIG. 4.

FIG. 2 illustrates an example of a transmitter 200. Elements of the transmitter 200 can have the characteristics described for the corresponding elements of the transmitter 100, except where noted otherwise or suggested otherwise by context. In FIG. 2, the marker generation circuit and optical source are omitted for clarity, but these elements (e.g., marker signal generation circuit 104 and optical source 114) can be included in the transmitter 200 and configured as described with respect to FIG. 1. In addition, although various elements and labeled and described with respect to modulator 202-1, it will be understood that modulator 202-2 can have the same structure, differing in the data signal and, optionally, the phase marker that is applied. In FIG. 2, solid lines indicate electrical transmission paths (e.g., traces, wiring, interconnects, etc.), and dashed lines indicate optical transmission paths such as waveguides and optical fibers.

The transmitter 200 includes, as modulators 102-1, 102-2, two traveling-wave Mach-Zehnder modulators (MZMs) 202-1, 202-2. The modulators 202-1, 202-2 each include a pair of transmission paths 220-1, 220-2 through which input light (e.g., from the optical source 114) is split and transmitted. The relative phase between light on the two transmission paths 220-1, 220-2 is changed based on the input data signal X or Y (e.g., using an electro-optical effect), and the light on the two transmission paths 220-1, 220-2 is then recombined. The relative phase between the light from the two transmission paths 220-1, 220-2 (e.g., with the MZM acting as a Mach-Zehnder interferometer) results in modulated output light (a modulated light signal) x or y that encodes or carries, or in which is embedded, X and Y, as amplitude modulations. The transmission paths 220-1, 220-2 can be referred to as “arms”of the interferometer.

In FIG. 2, data signals X and Y are illustrated as being provided by data signal sources 230-1 and 230-2. The data signal sources 230-1, 230-2 can themselves generate the data signals (e.g., as the data signal generation circuits 110-1, 110-2) or can be elements through which the data signals are provided to reach the modulators 202-1, 202-2, e.g., including wiring, cabling, impedance-matching elements, and/or the like. The data signal source 230-1 provides data signal X (an analog or digital electrical signal) to data inputs 224, 225. The data inputs 224, 225 are circuit nodes that receive data signal X in a differential manner and provides the data signal X for modulation. For example, data input 224 can receive +X/2 and data input 225 can receive −X/2. In the example of FIG. 2, the data input 224 is electrically connected to the data signal source 230-1 and to a diode 222-1 (in this example, an anode of the diode 222-1) using which modulation is performed based on the data signal X. Data input 225 is electrically connected to the data signal source 230-1 and to a diode 222-2 (in this example, an anode of the diode 222-2) using which modulated is also performed. Because the data signal X is received differentially at the diodes 222-1, 222-2, the diodes 222-1, 222-2 provide a net amplitude modulation. It will be understood that data signals can be provided to modulators in various suitable ways (e.g., non-differentially), without departing from the scope of this disclosure.

Modulator 202-1 includes a termination resistor 228 that can be composed of one or more discrete and/or integrated resistors. In some implementations, the termination resistor 228 is connected between the data inputs 224, 225. In some implementations, the termination resistor 228 is connected between diodes 222-1, 222-2 (e.g., between anodes or cathodes of the diodes). The termination resistor 228 can have an impedance-matching resistance that reduces reflection, e.g., can have a resistance matching a characteristic impedance or output impedance of the data signal source 230-1. For example, the termination resistor 228 can have a 90 Ω resistance.

The phase shifters within each modulator 202-1, 202-2 (e.g., used to form a Mach-Zehnder interferometer) can be various types in various implementations. The diodes 222-1, 222-2 represent the phase shifters and their terminals as lumped elements. In some implementations, light traveling through the transmission paths 220-1, 220-2 is modulated using a metal oxide semiconductor (MOS) capacitor accumulation mode structure. In such a structure, a voltage is applied across a MOS junction (e.g., metal/oxide (e.g., HfO2)/semiconductor (e.g., silicon) junction) to cause a change in carrier density in a waveguide (e.g., a silicon waveguide) forming the transmission path 220, resulting in a change in refractive index that causes a relative phase shift. Types of MOS capacitor accumulation mode structures include crystalline silicon, polysilicon, III-V material, transparent conducting oxide (TCO), and graphene-based structures. When the phase shifter is such a structure, the diodes 222-1, 222-2 can represent the MOS junction, and the two terminals of each diode 222-1, 222-2 can represent the electrodes of either side of the MOS junction. For example, one side of each MOS junction (connected to data inputs 224, 225) can receive the data signal X, and the other side of each MOS junction can receive a bias signal and, in the example of FIG. 2, a marker signal, as discussed in further detail below. “Receive the data signal,” as used herein, includes cases in which a modified, attenuated, filtered, or differential version of the data signal is received.

In some implementations, light traveling through each of the transmission paths 220-1, 220-2 is modulated using a depletion-mode (e.g., silicon depletion-mode) optical modulator. In such a structure, a voltage is applied across a reverse-biased pn junction/diode formed in a waveguide (e.g., a silicon waveguide). The change in reverse bias causes a change in carrier density in the depletion region of the diode, causing a change in refractive index that causes a relative phase shift. For example, one side of each pn diode (connected to data inputs 224, 225) can receive the data signal X, and the other side of each pn diode can receive a bias signal and, in the example of FIG. 2, a marker signal, as discussed in further detail below. Non-limiting examples of the depletion-mode optical modulator are described in U.S. Pat. Nos. 11,543,728 and 12,001,118, each of which is incorporated herein by reference. In such a device, the diodes 222-1, 222-2 can represent the diodes/junctions, and the two terminals of each diode 222-1, 222-2 can represent the anodes and cathodes of the diodes.

In some implementations, the modulators 220-1, 220-2 are thin-film LiNbO3 MZMs or InP MZMs. The diodes 222-1, 222-2 can represent thin-film LiNbO3 phase-shifters or InP phase-shifters.

As shown in FIG. 2, the diodes 222-1, 222-2 each receive a bias voltage V at a bias input 226. The bias voltage V can be a DC voltage or a low-frequency bias. For example, in the case where the diodes 222-1, 222-2 represent the diodes of depletion-mode modulators, the bias voltage V can be a bias that causes the diodes 222-1, 222-2 to be reverse-biased. In the example of FIG. 2, the bias input 226 is a cathode terminal of each diode 222-1, 222-2, and an anode terminal of each diode 222-1, 222-2 receives data signal X. It will be understood that in some implementations the diodes are connected oppositely, such that the bias input 226 is the anode terminal and data signals are applied to the cathode terminals. The bias voltage v can be provided by any suitable voltage source.

In transmitter 200, the marker signal v(t) (e.g., from the marker signal generation circuit 104) is applied at the same terminal/node receiving the bias voltage V, e.g., at the bias input 226 which is connected to (or is), in this example, the cathode of each diode 222-1, 222-2. This arrangement can provide several advantages. First, because the marker signal v(t) is applied to both arms differentially, there is no net change to the amplitude of the output optical signal x. Rather, the marker signal v(t) is a common-mode signal that causes an equal phase shift for light in both transmission paths 220-1, 220-2. When the light is then recombined at the output of the interferometer (to form the output optical signal x), the common-mode nature of the v(t) phase shift means that there is no change, or substantially no change, in the amplitude of x caused by v(t). Rather, x is phase-modulated with a time-dependent v(t) phase marker. The use of the phase marker rather than an amplitude marker can provide improved performance, e.g., because the phase marker does not interfere with the data signal with which x is modulated as amplitude modulation.

The marker signal generation circuit can provide V and v(t), e.g., can generate the bias voltage V and modulate V with the maker signal v(t).

As another advantage provided by the configuration of the bias input 226 in some implementations, because the marker signal v(t) is introduced into the modulator 202-1 at a low-frequency node, the inclusion of complex, expensive, and/or space-consuming circuitry can be avoided. For example, a simple, low-frequency bias tee or other simple circuit can be used to provide both the marker signal v(t) and the bias voltage v at the bias input 226. In some implementations, the bias voltage is itself generated by the marker signal generation circuit 104, e.g., as a DC component of a marker signal having time-varying component v(t). As noted above, providing the marker signal v(t) at a high-frequency node (e.g., the data input 224 at which the high-frequency data signal is provided) may, in some cases, require prohibitively complex, expensive, and/or space-consuming circuitry to do so without adding negative signal effects.

Providing the marker signal at the bias input can equivalently be understood or implemented as modulation of the bias voltage. For example, the bias voltage can be modulated with the marker signal v(t) to provide the phase modulation.

Modulator 202-2 is configured as described for modulator 202-1, except that the marker signal provided to the bias input in modulator 202-2 is −v(t), e.g., the opposite-polarity or complementary version of v(t). Accordingly, the output light signal y from modulator 202-2 is Y-modulated light with a −v(t) phase marker. The DP light signal output from PBSR 106 then includes two light signals with different polarities, the two light signals respectively encoding X and Y data signals and having a differential phase marker. The differential phase marker (e.g., with complementary v(t) phase modulation) can provide improved feedback and control for polarization demultiplexing. For example, the differential phase marker allows the marker amplitude to be split between the two light signals x and y, e.g., to obtain a 2v(t) voltage difference using +v(t) and −v(t) signals as opposed to using 2v(t) and 0 signals. The latter configuration may be associated with increased modulation of the bias voltage (e.g., a 2v(t) modulation as opposed to a v(t)) modulation, further shifting the bias voltage away from its optimum position and potentially resulting in performance penalties. Accordingly, the use of a differential phase marker can facilitate high performance levels. Further, the use of complementary phase markers (e.g., +v(t) and −v(t)) can simplify and/or improve the subsequent use of the phase markers for demultiplexing control, e.g., because the complementary phase markers can more easily be used in concert with one another for detection and control. Further, in some implementations, the use of differential phase markers can facilitate the cancellation of residual amplitude modulation, as discussed in further detail below.

However, in some implementations within the scope of this disclosure, a phase marker is applied to only one of the output light signals x or y, and DP transmission and signal recovery can be performed in those implementations as well.

In some implementations, this differential marker configuration can provide performance improvements, for example, compared to some systems in which a phase marker is applied at only one modulator or in which two non-differential phase markers are applied at two modulators (e.g., in which a v₃(t) phase marker is applied at a first modulator and a v4(t) phase marker is applied at a second modulator, where v₃(t)≠−v4(t)). The differential phase marker can be understood as a line on the surface of the Poincare sphere. Polarization demultiplexing (discussed with respect to FIG. 4) can entail, or be equivalent to, the placement of this line onto the S₁=0 plane, where S₁, S₂, and S₃ are the Stokes parameters representing position on the Poincare sphere.

In some implementations, modulation efficiency imbalances in the transmitter 200 may result in impaired performance. For example, the modulation efficiencies in each arm of the modulators 202-1, 202-2 may be different from one another. Because, in some implementations, the modulators 202-1, 202-2 are fabricated together and in close proximity (e.g., on a single chip or substrate), the efficiency imbalance may be the same for the two modulators 202-1, 202-2. The efficiency imbalance may result in differential amplitude modulation between the output light signals x and y, in addition to the desired phase modulation associated with the marker signal and the desired amplitude modulation associated with the signals X and Y. The differential amplitude modulation may degrade polarization control.

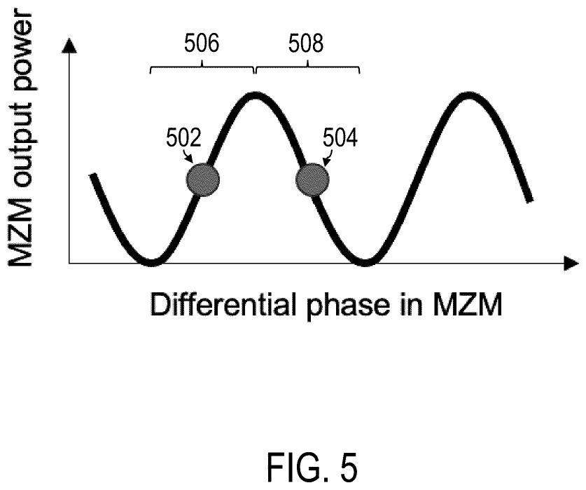

In some implementations, to at least partially remedy or avoid control degradation associated with differential amplitude modulation, the phase of the first modulator 202-1 can be set to be on the opposite slope of the second modulator 202-2. An example of this arrangement is illustrated in FIG. 5. FIG. 5 is a plot of MZM optical output power vs MZM differential phase, e.g., for each of the modulators 202-1, 202-2. The bias point for each modulator (e.g., as set by the bias voltage) is typically set to be around the half-way point of the wave, e.g., point 502 or 504, and the phases is modulated around that point. In some implementations, the phases of the two modulators 202-1 and 202-2 are set to be on opposite slopes from one another, e.g., based on the respective bias voltages applied to each. For example, the first modulator 202-1 can be set to operate at a point in range 506 (on the up-slope) and the second modulator 202-2 can be set to operate at a point in range 508 (on the down-slope), or vice-versa. For example, the first modulator 202-1 can be set to operate at point 502 and the second modulator 202-2 can be set to operate at point 504, or vice-versa. Accordingly, complementary outputs can be obtained. As a result, the sign of residual amplitude modulation is flipped and undesired amplitude modulation for the two modulators 202-1, 202-2 is changed from differential to common-mode. The common-mode amplitude modulation will not degrade polarization control.

In some cases, selection of the down-slope (e.g., point 504) will result in complementary data output/encoding. The input signal X or Y provided to the modulator set to operate on the down-slope can be inverted (flipped) to account for this effect.

FIG. 3 illustrates another example of a transmitter 300. Components of the transmitter 300 can have characteristics described for the corresponding components of the transmitters 100 and/or 200, except where noted otherwise or suggested otherwise by context. Further, signals and control associated with the transmitter 300 can have characteristics and be performed as described for transmitters 100 and/or 200, except where noted otherwise or suggested otherwise by context.

The transmitter 300 includes two modulators 302-1, 302-2 having data signal sources 330-1, 330-2 providing data signals X and Y to data inputs 324, 325. Phase-shifters, represented as diodes 322-1, 322-2, receive the data signals X or Y and, based on the data signals, modulate the amplitude of light (e.g., light from optical source 114) with X or Y. A bias voltage V₁ (e.g., a DC signal) is provided as a common-mode input to both diodes 322-1, 322-2 as a bias input 326.

In the transmitter 300, unlike in the transmitter 200, marker signals are applied through termination resistances/termination resistors of the modulators 302-1, 302-2. With reference to 302-1, a marker signal v(t) is applied through termination resistors 328-1, 328-2, which together form an overall termination resistance or termination resistor of the modulator 302. As discussed in reference to FIG. 2, each of the termination resistors 328-1, 328-2 can be composed of one or more discrete and/or integrated transistors. The marker signal v(t) is applied at a marker input 331 between the resistors 328-1, 328-2. The marker signal v(t) can optionally be applied to include, or can be applied at the same node as, a DC signal V₂. V₂ can provide, maintain, or result in reverse bias across the diodes 322-1, 322-2. For example, V₂ can be less than V₁ so that the diodes 322-1, 322-2 remain reverse-biased. For example, V₂ can be less than V₁ by at least a magnitude of v(t). In some implementations, the resistors 328-1, 328-2 represent resistances (i) between the marker input 331 and respective anodes of the diodes 322-1, 322-2 (or, as another example, respective cathodes), (ii) between the marker input 331 and connections to the data signal source 330-1 (e.g., data inputs 324, 325), or (i) and (ii). Capacitors 332-1, 332-2 are connected between data inputs 324, 325 and the marker input 331, to permit DC voltage input to the data signal sources 330-1, 330-2 (e.g., to SERDES) distinct from the DC voltage V₂. The capacitors 332-1, 332-2 are optional and need not be included.

In some implementations, the marker input 331 at which the marker signal v(t) is received is at a midpoint of the termination resistance. For example, the resistances of each of the termination resistors 328-1, 328-2 can be equal or substantially equal to one another, e.g., within 5% or within 10% of one another. Therefore, because the data signal X is differentially applied, a magnitude of the data signal X at the marker input 331 is zero or substantially zero. As such, the marker signal v(t) (which can have characteristics as described for the marker signals above in this disclosure) can be applied using relatively simple, low-cost components, and, for example, without requiring inductors (e.g., without being applied through an inductor). Inductors may be necessary if the marker signal v(t) at some other points, e.g., together with the data signal X, as discussed above.

The configuration of FIG. 3 can provide advantages as discussed in reference to FIG. 2. For example, the marker signal v(t) is a common-mode input with respect to the phase shifters represented by the diodes 322-1, 322-2. V(t) is applied equally (e.g., with equal attenuation) to respective anodes (or, in other implementations, cathodes) of the diodes 322-1, 322-2. As such, v(t) causes a phase shift in the X-modulated light (a v(t) phase marker) without modulating the amplitude, providing the corresponding advantages discussed above. For example, possible performance penalties associated with an amplitude-based phase marker can be mitigated or avoided.

The modulator 302-2 can have the structure and configuration described for the modulator 302-1. In some implementations, the marker signal received at and applied at the modulator 302-2 is −v(t), e.g., the complementary version of v(t), which can provide the advantages discussed above for FIG. 2.

Providing the marker signal at the input receiving V₂ can equivalently be understood or implemented as modulation of V₂. For example, V₂ (a bias voltage) can be modulated with the marker signal v(t) to provide the phase modulation.

FIG. 4 illustrates an example of a receiver 400 configured to operate based on the presence of the phase markers in x and/or y, the light signals output by the modulators 102-1 and 102-2, 202-1 and 202-2, or 302-1 and 302-2. As discussed in reference to FIG. 1, the light signals are combined at a PBSR 106 (or equivalent component(s)) and provided into a communication channel as a dual-polarization (DP) waveform. As shown in FIG. 4, the channel can include, for example, a fiber link 402. The DP waveform (which may be modified by transmission) is then received at the receiver 400.

The receiver 400 is configured to perform polarization demultiplexing on the DP waveform to recover X′′ and Y′′, recovered versions of X and Y. For example, the receiver 400 can be configured and have a structure as described in U.S. patent application Ser. No. 18/235,032. As an example, as shown in FIG. 4, the receiver 400 includes an optical module 404 and an electrical module 406. At the receiver 400, the DP waveform enters a PBSR 408 which splits the DP waveform into two optical waveforms (h and v, transmitted on respective optical transmission paths) that have orthogonal polarizations. Due to one or more effects (e.g., the optical communication system not using polarization-maintaining fiber), the optical outputs of the PBSR 208 (h and v) are each a linear and orthogonal combination of the originally transmitted optical signals x and y. The two optical signals (light) h and v are input to an optical MIMO demultiplexer 410, which performs an initial step of demultiplexing in the optical domain to output optical signals (light) x′ and y′ on respective optical transmission paths. For example, the optical MIMO demultiplexer 410 can be a 2×2 optical MIMO demultiplexer having multiple sets of differential phase shifters. For example, the optical MIMO demultiplexer 410 can be an endless demultiplexer.

The optical signals x′ and y′ that are output from the optical MIMO demultiplexer 410 are photodetected by respective photodetectors 412, 414. The photodetectors 412, 414 output electrical signals (e.g., currents and/or voltages) X′ and Y′ representing the power of respective optical fields of the optical signals x′ and y′. The signals from the photodetectors 412, 414 are optionally provided into transimpedance amplifiers 416, 418 that produce amplified versions of the signals from the photodetectors, also referred to as X′ and Y′.

The electrical signals X′ and Y′ are then input to an electrical MIMO demultiplexer 420 which performs demultiplexing in the electrical domain to produce separate signals X″ and Y″. X″ and Y″ represent recovered versions of the original data signals X and Y shown in FIG. 1. The electrical MIMO demultiplexer 420 can include, for example, a butterfly network with controllable gain elements.

The presence of the phase markers in x and y can be used to control the optical MIMO demultiplexer 410 and/or the electrical MIMO demultiplexer 420. For example, a controller 450 (e.g., a computing device, programmable chip, field-programmable gate array, integrated circuit, and/or the like) can provide control signals to one or more phase-shifters in the optical MIMO demultiplexer 410 and/or to one or more variable gain elements in the electrical MIMO demultiplexer 420. The control signals can include currents and/or voltages and can be analog and/or digital signals. For example, the signals can adjust phase shifts applied by the one or more phase-shifters and/or gain applied by the one or more variable gain elements.

The controller 450 can generate the control signals based on feedback from the phase markers v(t) in X″ and/or Y″. For example, the controller 450 can receive output signals X″ and Y″ from outputs of the electrical MIMO demultiplexer 420, or derivatives thereof (e.g., filtered, analog-to-digital converted (ADC), digital-to-analog converted (DAC), and/or otherwise processed versions of the output signals X″ and Y″ and/or data obtained by processing the output signals X″ and Y″). In some implementations, the controller 450 extracts the phase markers v(t) from X″ and/or Y″ or receives the phase markers v(t) extracted from X″ and/or Y″. The controller 450, using the extracted v(t) (which may differ from v(t) as applied at the transmitter), can adjust the control signals so as to optimize one or more figures of merit based on v(t), e.g., to maximize eye opening, minimize bit-error count, maximize a signal quality, minimize an unwanted tone marker component, and/or apply other known signal quality monitoring technique(s).

For example, if +v(t) and −v(t) phase markers are added differentially to x and y as shown in FIGS. 2-3, the controller 450 can generate the control signals so as to minimize a magnitude of the sum of phase markers extracted from each of X″ and Y″, e.g., by suitably adjusting controllable gain elements of the electrical MIMO demultiplexer 420 in a feedback process.

As another example, a position of the phase marker on the Poincare sphere can be detected by the controller 450, and the controller can perform demultiplexing control based on the detected position. For example, control can be performed to shift the phase marker onto the S₁=0 plane. In some implementations, this process can include detecting Stokes parameters, e.g., as described in US Publication No. 2023/0396340, the entirety of which is incorporated herein by reference. This process can provide direct, fast control with high performance demultiplexing.

Accordingly, markers can be added to signals in order to facilitate demultiplexing. The markers can be added at a modulator in a common-mode configuration so as to modulate signal phase rather than amplitude, preserving signal quality and providing for simple introduction of the phase marker signal to the transmitter circuit. Differential (e.g., complementary) phase markers can be applied at two modulators in a dual-polarization transmitter to provide improved performance.

The examples of architectures of optical and electrical systems described herein are not exhaustive. For example, extra optical and/or electrical components can be included in the direct detection receivers described herein without departing from the scope of this disclosure, such as optical and/or electrical filters, amplifiers/attenuators, splitters, couplers, etc. Moreover, in some implementations, one or more optical and/or electrical component shown in the described detection receivers can be omitted, without departing from the scope of this disclosure. In addition, unless otherwise indicated, signals and light described as being “from” a component need not be directly from the component but, rather, can have been processed in one or more ways. For example, an output received “from” a demultiplexer need not be the direct output from the demultiplexer but may have been amplified, attenuated, filtered, etc., before being received.

While this disclosure contains many specific implementation details, these should not be construed as limitations on the scope of any invention or of what may be claimed, but rather as descriptions of features that may be specific to particular implementations of particular inventions. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

1. An optical system comprising:
a first modulator configured to:
receive first input light,
modulate an amplitude of the first input light with a first data signal,
modulate a phase of the first input light with a first marker signal, and
output to an optical element, as first modulated light, the first input light modulated with the first data signal and the first marker signal; and
a second modulator configured to:
receive second input light,
modulate an amplitude of the second input light with a second data signal,
modulate a phase of the second input light with a second marker signal, and
output to the optical element, as second modulated light, the second input light modulated with the second data signal and the second marker signal,
wherein the second marker signal comprises a complementary version of the first marker signal.

2. The optical system of claim 1, wherein modulation of the phase of the first input light and modulation of the phase of the second input light are based on modulation of bias voltages of the first modulator and the second modulator, respectively.

3. The optical system of claim 1, comprising a marker signal generation circuit configured to provide the first marker signal with a frequency in a range from 100 kHz to 500 MHz.

4. The optical system of claim 2, comprising a data signal generation circuit configured to provide the first data signal with a frequency of at least 1 GHz.

5. The optical system of claim 1, wherein the first modulator is configured to modulate the phase of the first input light with the first marker signal at a frequency in a range from 100 kHz to 500 MHz.

6. The optical system of claim 1, comprising:
a laser source configured to output laser light; and
an optical splitter configured to split the laser light into a first transmission path and a second transmission path,
wherein the first transmission path provides the split laser light to the first modulator as the first input light, and
wherein the second transmission path provides the split laser light to the second modulator as the second input light.

7. The optical system of claim 1, wherein the optical element comprises a polarization splitter and rotator (PSR).

8. The optical system of claim 7, comprising a receiver configured to perform dual-polarization demultiplexing to recover the first data signal and the second data signal.

9. The optical system of claim 8, wherein the receiver is configured to perform the dual-polarization demultiplexing using the first marker signal and the second marker signal.

10. The optical system of claim 1, wherein the first modulator and the second modulator comprise Mach-Zehnder interferometer modulators.

11. The optical system of claim 1, wherein the first modulator and the second modulator comprise ring resonator modulators.

12. The optical system of claim 1, wherein the optical system comprises a dual-polarization optical system.

13. An optical transmitter comprising:
an optical modulator comprising at least one data input and a bias input, the bias input distinct from the at least one data input,
wherein the optical modulator is configured to:
receive a data signal at the data input and modulate an amplitude of light with the data signal,
receive, at the bias input, a bias signal and a marker signal, and
modulate a phase of the light with the marker signal.

14. The optical transmitter of claim 13, wherein the bias signal comprises a DC signal and the marker signal comprises an AC signal.

15. The optical transmitter of claim 13, wherein the optical modulator comprises a Mach-Zehnder interferometer, and
wherein the bias input is a common bias input for two arms of the Mach-Zehnder interferometer.

16. The optical transmitter of claim 15, wherein the common bias input comprises a diode anode of each of the two arms or a diode cathode of each of the two arms.

17. The optical transmitter of claim 13, comprising:
a first optical phase-shifter connected between the bias input and a first data input of the at least one data input, and
a second optical phase-shifter connected between the bias input and a second data input of the at least one data input,
wherein the first optical phase-shifter and the second optical phase-shifter are connected as an interferometer to modulate the amplitude of the light.

18. The optical transmitter of claim 17, wherein the first optical phase-shifter and the second optical phase-shifter comprise depletion-mode phase-shifters.

19. The optical transmitter of claim 13, comprising a marker signal generation circuit configured to generate the marker signal and apply the marker signal to the bias input.

20. The optical transmitter of claim 13, comprising a marker signal generation circuit configured to modulate the bias signal with the marker signal.

21. The optical transmitter of claim 13, wherein the optical modulator is a first optical modulator configured to output the light as first output light,
wherein the marker signal is a first marker signal,
wherein the optical transmitter comprises a second optical modulator, and
wherein the second optical modulator is configured to modulate a phase of second output light with a second marker signal comprising a complementary version of the first marker signal.

22. The optical transmitter of claim 21, wherein the first optical modulator and the second optical modulator are coupled together by a polarization splitter and rotator.

23. The optical transmitter of claim 13, wherein the optical transmitter is a dual-polarization optical transmitter.

24. The optical transmitter of claim 13, comprising silicon waveguides through which the light is routed.

25.-51 (canceled)
